(19) United States
(12) Patent Application Publication
(10) Pub. No.: US 2025/0307004 A1
(43) Pub. Date: Oct. 2, 2025

(54) CONTEXTUALLY NOTIFYING USERS OF ISSUES AFFECTING RELEVANT WORKLOADS

(71) Applicant: Microsoft Technology Licensing, LLC, Redmond, WA (US)

(72) Inventors: Maya PEGLER-GORDON, Los Angeles, CA (US); Jeremy HAUBOLD, Portage, IN (US); Daniel MOCK, Ormond Beach, FL (US); Mellissa Lorna-Anne MARIE, Redmond, WA (US)

(73) Assignee: Microsoft Technology Licensing, LLC, Redmond, WA (US)

(21) Appl. No.: 18/616,612

(22) Filed: Mar. 26, 2024

(51) Int. Cl. G06F 9/50

(52) U.S. Cl. CPC G06F 9/5027

(57) ABSTRACT

A data processing system implements receiving, at a notification application programming interface (API), outage information indicating that one or more components of an engineering system are experiencing an outage; adding an outage record to a notifications datastore based on the outage information; receiving, at the notification API, a request for outage information from an outage portal, the request including information identifying a respective component of the one or more components of the engineering system for which notifications are being requested, the respective component being associated with a user of the outage portal; querying the notifications datastore to obtain a notification that the respective component is experiencing the outage; providing the notification to the outage portal via the notification API; and causing the outage portal to present the notification on a user interface of the outage portal.

### BACKGROUND

Software engineering utilizes complex engineering systems for developing, testing, and deploying software to target systems. Like any complex computing environment, these engineering systems can experience outages that impact one or more components of the engineering systems. Such outages may be broad outages that impact all or many of the users of the engineering system or local outages that impact smaller numbers of users. Current incident management notification systems do not provide the ability to target specific users, providing global notifications to all users. Without the ability to provide targeted alerts scoped to the impacted entities, engineers may waste significant amounts of time and computing resources attempting to determine whether reported failures are relevant to their respective workloads or a standard failure in the pipeline that caused the failure. Such a standard failure may be an ongoing outage of a workload within the pipeline or may have been caused by a change introduced by the user. Hence, there is a need for improved systems and methods that provide contextually relevant notifications that notify engineers of outages which impact the ability of the engineers to develop, build, test, and/or deploy software in an engineering system.

### SUMMARY

An example data processing system according to the disclosure includes a processor and a memory storing executable instructions. The instructions when executed cause the processor alone or in combination with other processors to perform operations including receiving, at a notification application programming interface (API), outage information indicating that one or more components of an engineering system are experiencing an outage; adding an outage record to a notifications datastore based on the outage information; receiving, at the notification API, a request for outage information from an outage portal, the request including information identifying a respective component of the one or more components of the engineering system for which notifications are being requested, the respective component being associated with a user of the outage portal; querying the notifications datastore for the respective component to obtain the outage record associated with the one or more components of the engineering system; generating the first notification that the respective component is experiencing the outage based on the outage record; providing the first notification to the outage portal via the notification API; and causing the outage portal to present the first notification on a user interface of the outage portal.

An example method implemented in a data processing system includes receiving, at a notification application programming interface (API), outage information indicating that one or more components of an engineering system are experiencing an outage; adding an outage record to a notifications datastore based on the outage information; receiving, at the notification API, a request for outage information from an outage portal, the request including information identifying a respective component of the one or more components of the engineering system for which notifications are being requested, the respective component being associated with a user of the outage portal; querying the notifications datastore for the respective component to obtain the outage record associated with the one or more components of the engineering system; generating the first notification that the respective component is experiencing the outage based on the outage record; providing the first notification to the outage portal via the notification API; and causing the outage portal to present the first notification on a user interface of the outage portal.

An example data processing system according to the disclosure includes a processor and a memory storing executable instructions. The instructions when executed cause the processor alone or in combination with other processors to perform operations including obtaining outage information at a first user interface of an outage portal configured to enable authorized users to create and view outage information for outages in an engineering system, the outage information indicating that one or more components of an engineering system are experiencing an outage; sending the outage information to a notification application programming interface (API) of a notification platform; receiving a request for outage information from a second user interface of the outage portal, the request including information identifying a respective component of the one or more components of the engineering system for which notifications are being requested, the respective component being associated with a user of the outage portal; receiving, from the notification API, a first notification indicative of an outage impacting the respective component of the one or more components; and presenting the first notification on the second user interface of the outage portal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of a contextual news and notifications platform that implements the techniques provided herein.

FIG. 2 is a diagram of an example computing environment in which the contextual news and notifications platform shown in FIG. 1 is implemented.

FIG. 3A-3F are diagrams showing an example user interface of a development operations application that implements root cause analysis according to the techniques disclosed herein.

FIGS. 4A-4C are diagrams showing an example user interface of an administration portal that implements root cause analysis according to the techniques disclosed herein.

FIG. 5A is a flow chart of an example process for providing contextually relevant notifications according to the techniques disclosed herein.

FIG. 5B is a flow chart of another example process for providing contextually relevant notifications according to the techniques disclosed herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Systems and methods for providing contextually relevant notifications to users of an engineering system are provided. These techniques provide a technical solution to the problems associated with current systems which provide global notifications of incidents to all users, irrespective of whether the incident impacts the ability of those users to develop, test, and/or deploy software due to the specific components of the engineering system impacted by an incident. The techniques herein provide a contextually relevant news and notifications (CNN) platform that provides contextually relevant notifications to users of an engineering system. These notifications can be generated in response to an incident resulting in an outage of one or more components of the engineering systems. The notifications are precisely scoped to impacted components of the engineering system, and the notifications are selectively surfaced on relevant entities, such as but not limited to pull requests, the pipelines interface, and/or the command line interface. A technical benefit of these techniques is that the notifications are provided to users impacted by outages without interrupting the workflow of those users who are not impacted by the outages.

In addition to the contextually relevant notifications, the CNN platform also provides automatic reinitialization of impacted components once the outage has been resolved. The CNN platform intelligently distributes the retry attempts to help mitigate a potential surge of retries that often follow an outage resolution. A technical benefit of this approach is that the CNN platform avoids such surges in which multiple components of the engineering system are reinitialized simultaneously. Such surges can consume significant computing resources, which can cause secondary issues which would in turn need to be resolved. These and other technical benefits of the techniques disclosed herein will be evident from the discussion of the example implementations that follow.

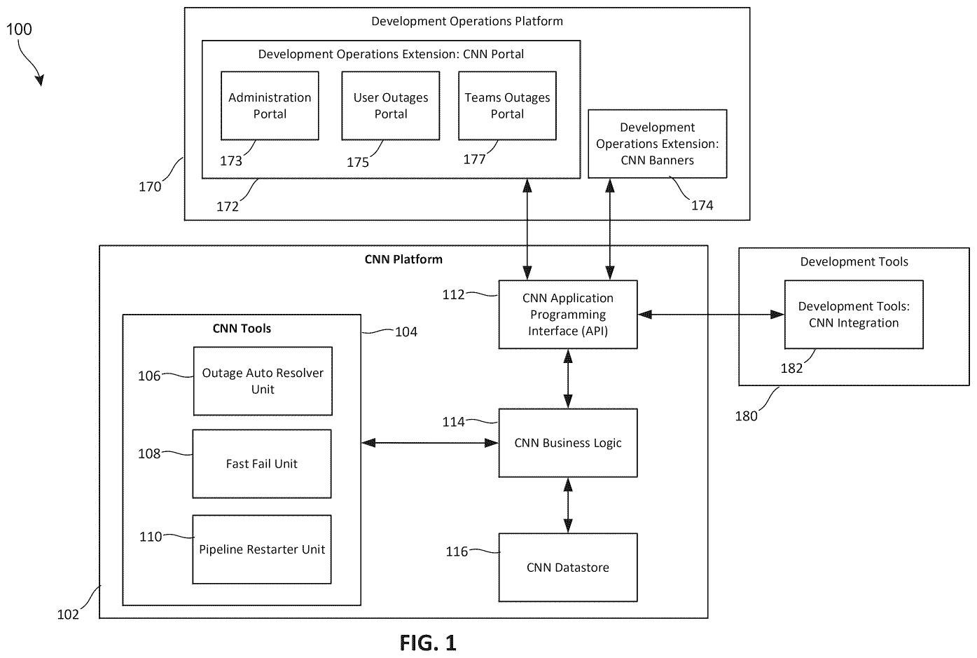

FIG. 1 is a diagram of a CNN platform 102 that implements the techniques provided herein. The CNN platform 102 is part of an engineering system 100 that facilitates software development, including a development operations (DevOps) platform 170 and a development tools 180.

The CNN platform 102 provides contextually relevant notifications to users when pipelines and/or pull requests associated with the user are currently being impacted or have been impacted by an incident that resulted in an outage of one or more components of the engineering system. Pipelines are a set of automated processes and tools that enable engineers to build and deploy code to a production environment. Various types of pipelines may be supported, including but not limited to build pipelines, release pipelines, and multi-stage pipelines. Build pipelines, also referred to as continuous integration (CI) pipelines, are triggered by changes to source code. Build pipelines perform various tasks, such as but not limited to code compilation, code quality analysis, unit testing, and generation of deployable build artefacts. Release pipelines or continuous delivery (CD) pipelines deploy the build artifacts to various target environments. The release pipelines automate various aspects of the deployment process, including but not limited to environment provisioning of the target environment, configuration of the target environment, and deploying the artifacts to the target environment. Multi-stage pipelines integrate CI and CD operations into a comprehensive workflow. Multi-stage pipelines can be used in place of separate build and release pipelines. An engineering environment can include multiple build pipelines, release pipelines, and/or multi-state pipelines.

Pull requests are used to merge a set of proposed changes from one branch of a software codebase into another branch. Pull requests can be used to integrate new functionality and/or bug fixes into the main codebase of software, which may then be tested and deployed for use by end users. The pull requests display differences between the content in a source branch, which includes the software changes made to implement the new feature or bug fix, and a target branch, which includes the code to which the changes are to be added. The pull requests are typically peer reviewed before the changes made in the source branch are merged with the target branch. In the scenario that a pipeline associated with a given pull request is experiencing a service degradation, the CNN platform 102 notifies users associated with the pull request through surfacing a banner on the pull request.

The CNN platform 102 provides tools for generating contextually relevant notifications of incidents that result in outages of components of the engineering system that can impact one or more pipelines, pull requests, or broad product suites. These notifications are presented on various user interfaces, such as but not limited to a pull request user interface, a command line interface, a pipeline user interface, and a CNN portal. Examples of these user interfaces are provided in the examples that follow. The CNN platform 102 provides a CNN application programming interface (API) 112 that provides an interface for the DevOps platform 170 and the development tools 180 to access functionality provided by the CNN platform 102. The CNN API 112 enables the DevOps platform 170, the development tools 180, and/or other components external to the CNN to access at least a portion of the functionality implemented by the CNN business logic 114. The CNN API 112 is secured with a custom authentication attribute specified by the configuration of the CNN platform 102. The authentication attribute ensures that requests from the DevOps platform 170 and/or the development tools 180 were initiated by an authorized user.

The CNN business logic 114 implements the various functions of the CNN platform 102 disclosed herein. The CNN business logic 114 is implemented separately from the CNN API 112 to facilitate execution of the CNN business logic 114 by back-end components of the engineering system without requiring authentication.

The CNN platform 102 also implements CNN tools 104. The CNN tools 104 provide functionality for automatically reinitializing components of the engineering system once an outage has been resolved. The CNN business logic 114 provides the underlying functionality for the CNN tools 104 in some implementations. The CNN tools 104 include an outage auto resolver unit 106, a fast fail unit 108, and a pipeline restarter unit 110 in the implementation shown in FIG. 1. Other implementations can include additional tools and/or other tools. Furthermore, the outage auto resolver unit 106, a fast fail unit 108, and a pipeline restarter unit 110 are implemented as separate components of the CNN tools 104 that each can be selectively enabled or disabled.

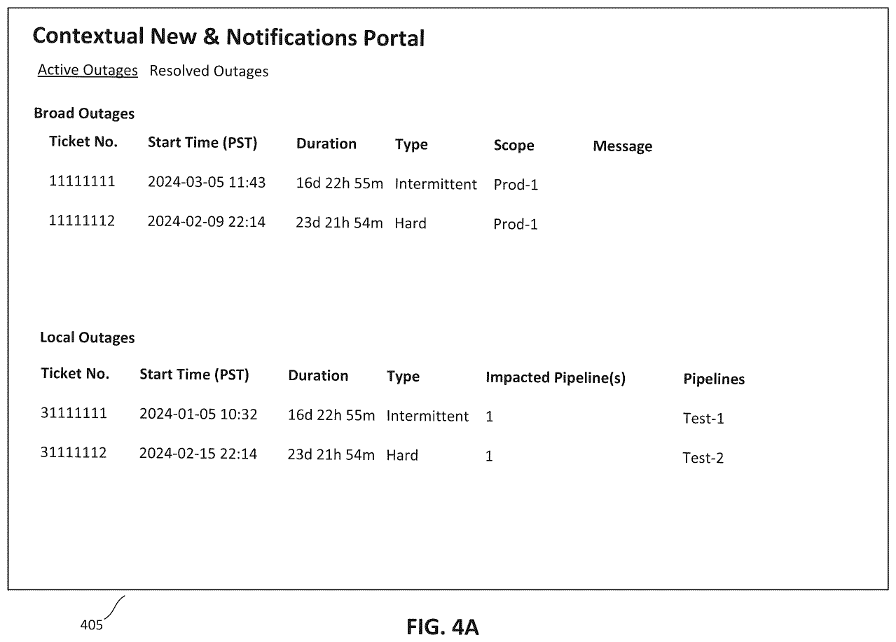

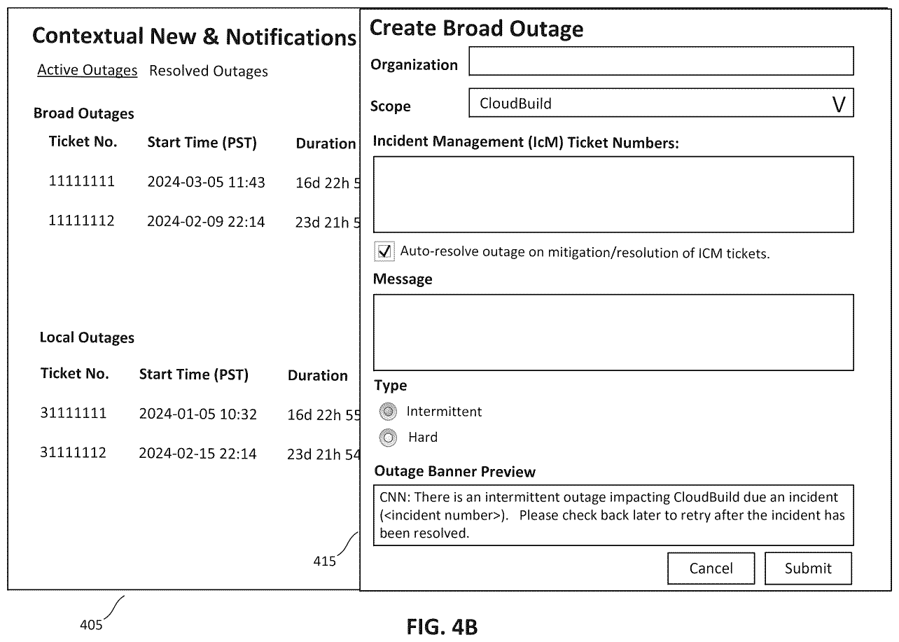

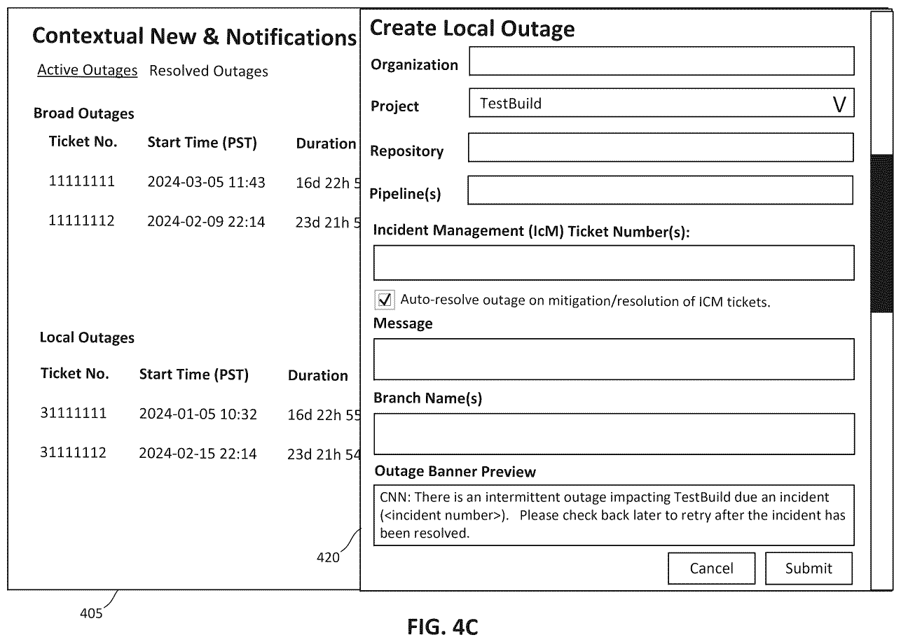

The outage auto resolver unit 106 automatically resolves an outage in response to the resolution of incident management (ICM) tickets associated with the outage. Once all of the tickets have been resolved or mitigated, the outage is presumed to have been resolved and the outage auto resolver unit 106 updates the outage record in the CNN datastore 116 to indicate that the outage has been resolved. The CNN portal 172 provides an administration portal 173 that enables authorized users to create new outage instances, view outage information for previously created outages, and/or modifying outage information for previously created outages. An example user interface for such an administration portal 173 is shown in FIG. 4A-4C, which are discussed in detail in the examples which follow. The CNN business logic 114 stores the outage information in the CNN datastore 116, which is a persistent datastore in a memory of the CNN platform 102. The CNN datastore 116 is updated to indicate that the ICM tickets are resolved as the tickets have been resolved by engineers working on these incidents. The updates to the ticket status may be input via the administration portal 173 in some implementations. The outage auto resolver unit 106 monitors the status of the ICM tickets associated with each of the outage records in the CNN datastore 116 and performs actions in response to the outage being resolved in response to each of the ICM tickets associated with an outage being resolved.

One action that the outage auto resolver unit 106 takes is to initiate the pipeline restarter unit 110 to attempt to restart one or more pipelines that were halted in response to the outage. The pipelines associated with the outage are defined in the outage information maintained in the CNN datastore for each outage.

The pipeline restarter unit 110 attempts to restart one or more pipelines that were halted in response to an outage. The pipeline restarter unit 110 monitors the outage records in the CNN datastore 116 and attempts to restart pipelines that were previously halted in response to an outage but the outage has been resolved or mitigated. The pipeline restarter unit 110 updates the CNN datastore 116 to indicate that the pipeline restart unit 110 is attempting to restart the pipeline.

The fast fail unit 108 halts the pipelines of the engineering system that are impacted by at least one outage. The fast fail unit 108 temporarily prevents the pipeline from being instantiated while the cause of an outage is being resolved. A technical benefit of this approach is that it conserves computing resources by preventing the engineering system from attempting to instantiate a pipeline that is going to ultimately fail due to the outage. Without such a failsafe, users and automated services may repeatedly attempt to instantiate a pipeline to build, test, and/or deploy software. The computing resources that would be allocated to such ultimately unsuccessful attempts to instantiate the pipeline can instead be allocated to other pipelines or components of the engineering system that are not experiencing such an outage. In some implementations, the fast fail unit 108 sets an indicator associated with a pipeline that should be prevented from being initialized in the CNN datastore 116. Each time that the DevOps platform 170 or another component of the engineering system attempts to instantiate the pipeline, a query is made to the CNN API 112 requesting the fast fail status of that pipeline. The pipeline can then be instantiated if the fast fail status indicator indicates that the pipeline may be instantiated. A technical benefit of this approach is that significant amounts of computing and engineer resources that would otherwise be dedicated to requeuing the pipelines and investigating failure logs.

The pipeline restarter unit 110 restarts a pipeline associated with an outage. The pipeline restarter unit 110 can allocate computing resources for the pipeline, configure these resources, and instantiate various processes associated with the pipeline. The pipeline restarter unit 110 is utilized by the CNN platform 102 to attempt to restart the pipeline in response to an intermittent failure. The pipeline restarter unit 110 is utilized by the CNN platform 102 to attempt to restart a pipeline in response to an indication from the outage auto resolver unit 106 indicating that the outage associated with the pipeline has been resolved. The outage auto resolver unit 106 provides the indication that the outage has been resolved to the pipeline restarter unit 110 after the fast fail unit 108 resets the fast fail status so that the pipeline is permitted to be restarted. The pipeline restarter unit 110 is configured to intelligently distribute the attempts to restart the pipelines to mitigate a potential surge of retries that may follow an outage resolution. In one non-limiting example implementation, the pipeline restarter unit 110 estimates the computing resources required to initialize each pipeline and identifies the available computing resources and selects one or more pipelines to initialize based on the available resources. The pipeline restarter unit 110 delays the restart of the other pipelines until sufficient computing resources become available. In some implementations, the pipeline restarter unit 110 prioritizes pipelines that have one or more other pipelines that dependent upon them to be reinitialized sooner than the dependent pipelines. For instance, the pipeline restarter unit 110 would prioritize a build pipeline to be reinitialized before a release pipeline dependent upon the output of the build pipeline. A technical benefit of this approach is that the pipeline restarter unit 110 avoids surges in computing resource utilization when the surges could result in secondary issues that can negatively impact the performance of the engineering system. Another technical benefit of this approach is that significant amounts of computing and engineer resources that would otherwise be dedicated to manually monitoring the status of the pipelines and manually requeuing the pipelines.

The DevOps platform 170 provides tools that provide various functions such as version control for program code, reporting, requirements management, project management, automated builds, testing and release management. The DevOps platform 170 implements the pipelines discussed herein for building, testing, and deploying software in the engineering system. The DevOps platform 170 is implemented using Microsoft Azure DevOps in some implementations. The DevOps platform 170 implements a first extension, the CNN portal 172, and a second extension, and the CNN banners extension 174. The CNN portal 172 provides an interface for viewing, previewing, creating, modifying, and resolving outages. The administration portal 173 provides a user interface that enables authorized users to create, modify, and/or delete outages. Examples of this user interface are shown in FIGS. 4A-4C and are discussed in detail in the examples that follow. The user outages portal 175 provides a user interface that allows users to access outage information for outages that impact pull requests and/or pipelines related to projects associated with the user. The teams outages portal 177 is another user interface that allows the user to access outage information for outage information for pull requests and/or pipelines associated with teams for which the user is a member.

The development tools 180 are tools that facilitate writing and/or editing of program code to be built, tested, and/or deployed. The CNN integration 182 integrates the CNN notifications into the development tools 180. The CNN integration 182 queries the CNN platform 102 for outage notifications via the CNN API 112 and presents any contextually relevant outage information on a user interface of the development tools 180. The notifications may be obtained based on user information associated with a user of the development tools 180 and/or the components of the engineering system associated with the program code being written and/or edited in the development tools 180.

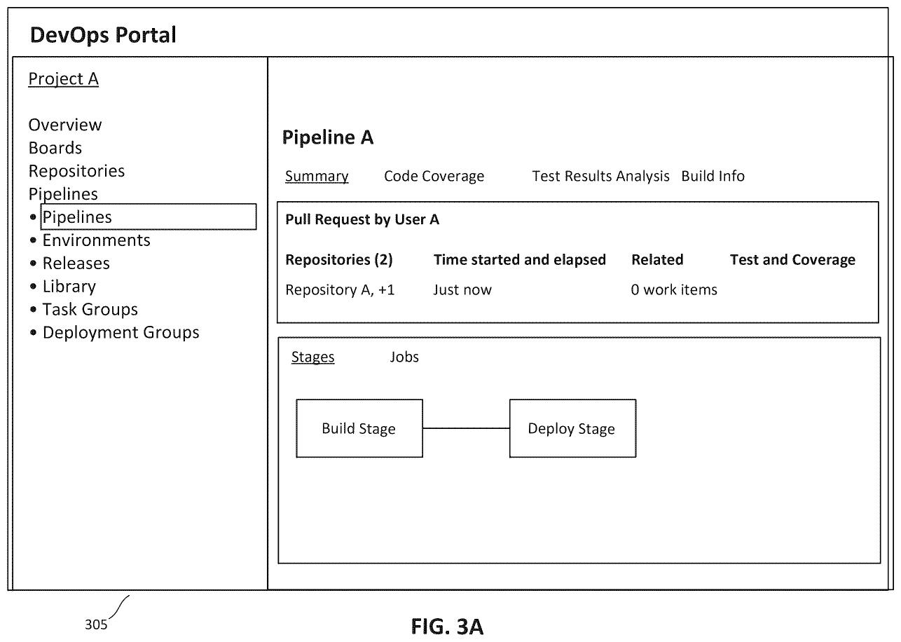

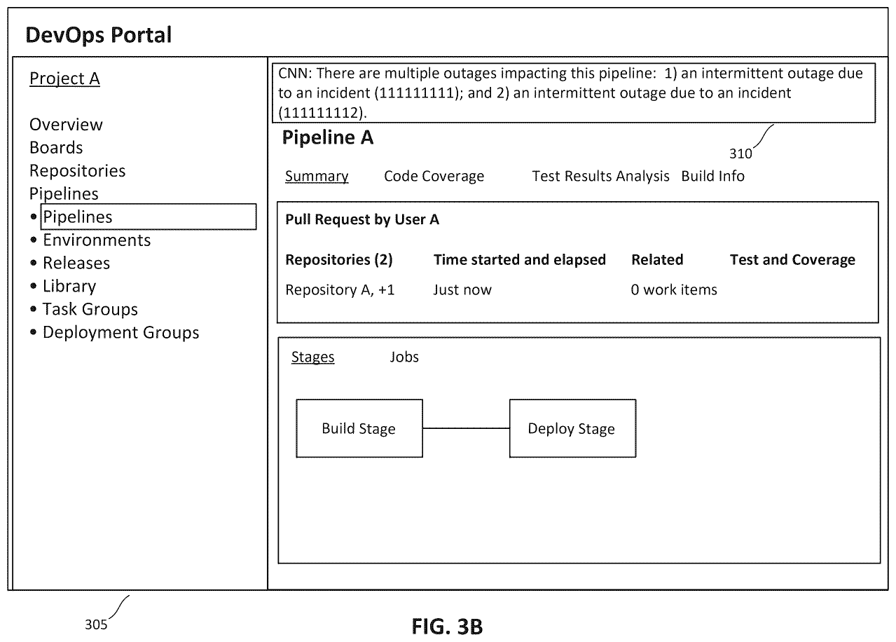

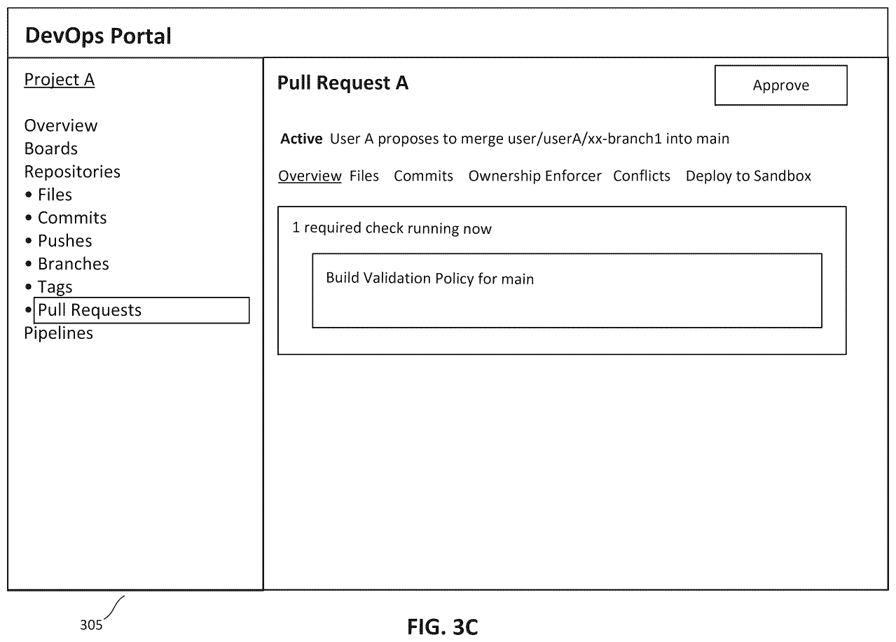

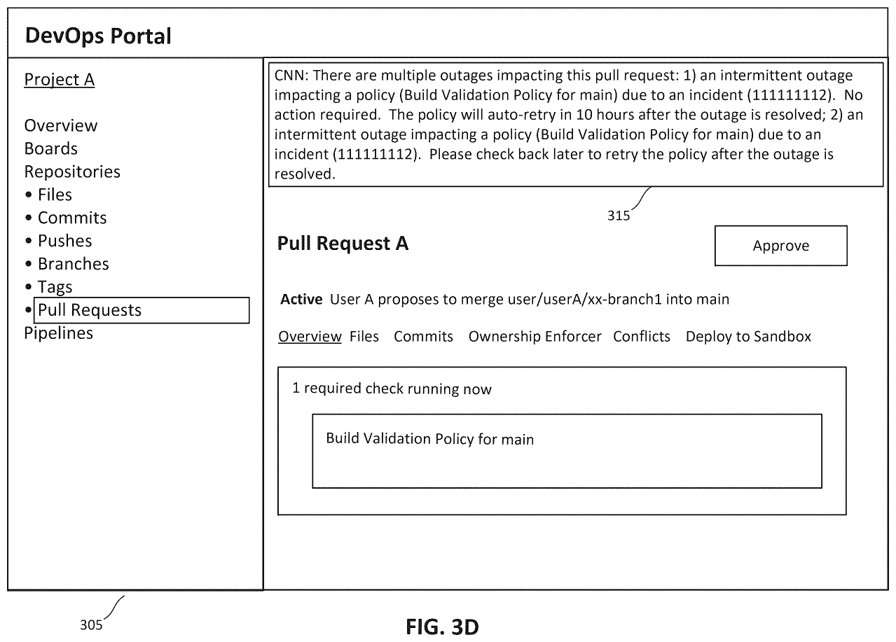

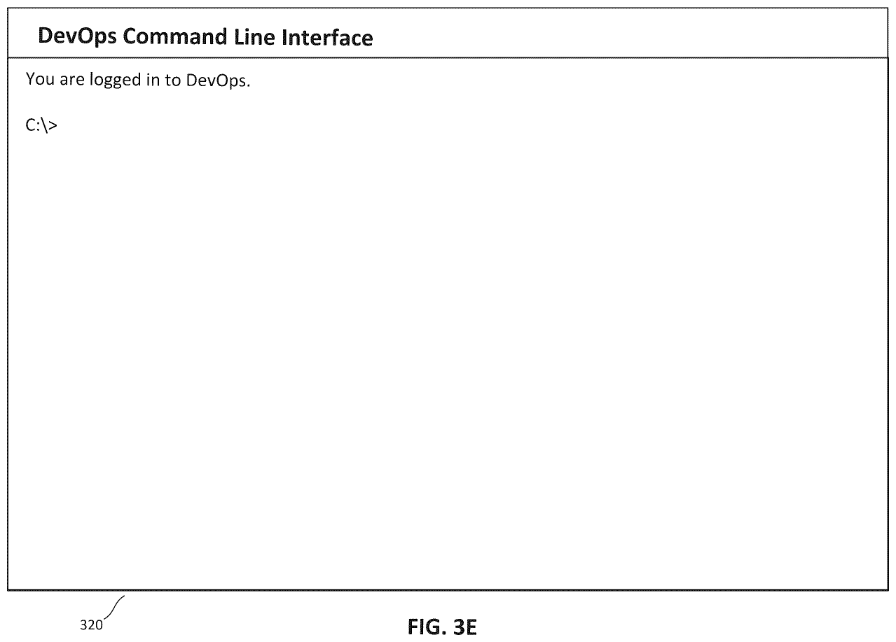

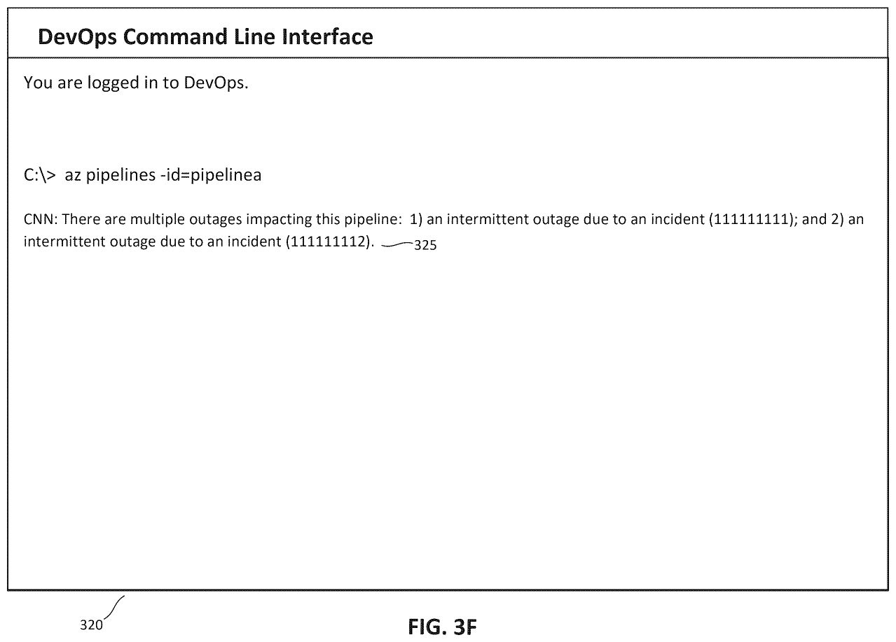

The CNN banners extension 174 implements notifications on the various user interfaces implemented by the CNN portal 172. These notifications are contextually relevant for the users to which the notifications are presented. Examples of the notifications are presented in FIGS. 3A-3F, which are discussed in detail in the examples which follow.

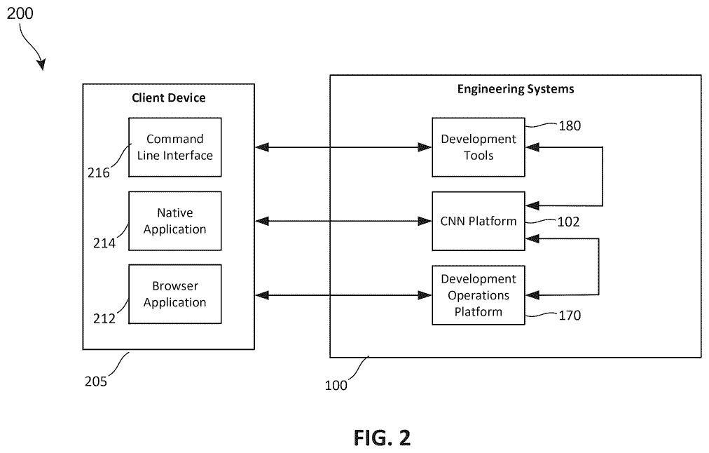

FIG. 2 is a diagram of an example computing environment 200 in which the CNN platform 102 shown in FIG. 1 is implemented. The CNN platform 102, the development tools 180, and the DevOps platform 170 shown in FIG. 1 are implemented on the engineering systems 100. The engineering systems 100 are a cloud-based computing environment that provides engineers with tools for developing, building, testing, and/or deploying software projects.

The client device 205 provides a means for users to access the services of the engineering systems 100. The client device 205 and the engineering systems 100 communicate with each other over a network (not shown). The network may be a combination of one or more public and/or private networks and may be implemented at least in part by the Internet.

The client device 205 is a computing device that may be implemented as a portable electronic device, such as a mobile phone, a tablet computer, a laptop computer, a portable digital assistant device, a portable game console, and/or other such devices in some implementations. The client device 205 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 2 includes a single client device 205, other implementations may include a different number of client devices that utilize services provided by the engineering systems 100.

The client device 205 includes a native application 214, a browser application 212, and a command line interface 216. The native application 214 is a web-enabled native application, which implements the CNN portal 172 shown in FIG. 1 in some implementations. The native application can implement the user interfaces shown in FIGS. 3A-3F and 4A-4C. The browser application 212 can be used for accessing and viewing web-based content provided by the engineering systems 100. In such implementations, the engineering systems 100 implements one or more web applications. The web application can implement the user interfaces shown in FIGS. 3A-3F and 4A-4C. The engineering systems 100 supports both the native application 214 and a web application in some implementations, and the users may choose which approach best suits their needs. The command line interface 216 enables users of the client device 205 to interact with the CNN platform 102, the DevOps platform 170, and/or the development tools 180 by entering text commands.

FIGS. 3A-3D show an example user interface 305 of a DevOps portal that can implement the user outages portal 175 and/or the teams outages portal 177. FIG. 3A shows an example in which the user is viewing the pipeline information for pipelines that the user has permission to access. The example shown in FIG. 3A shows pipeline information associated with the user, but the user interface can also be adapted to show similar information for teams for which the user is a member. FIG. 3B shows an example of the user interface 305 which includes a banner 310 that provides outage information for Pipeline A to the user. The CNN banners extension 174 is integrated with the user interface 305 and obtains the outage information for each of the pipelines associated with the user via the CNN API 112. The CNN portal 172 provides the portal information to the CNN banners extension 174 and the CNN banners extension 174 queries the CNN platform 102 for outage information via the CNN API 112.

FIG. 3C shows an example of the user interface 305 in which the user has viewed a pull request associated with the user. The user interface 305 can also be adapted to show pull request information for teams for which the user is a member. FIG. 3D shows an example of the user interface 305 which presents a banner 315 that provides outage information for Pull Request A to the user. The CNN banners extension 174 obtains the outage information for each of the pull requests associated with the user via the CNN API 112.

FIG. 3E is an example of a user interface 320 which provides a command line interface for accessing and interacting with the DevOps platform 170. The user interface 320 is implemented by the command line interface 216 on the client device 205 in some implementations. In other implementations, the user interface 320 is implemented by the native application 214 and/or by the CNN portal 172. FIG. 3F shows an example of the command line interface in which the CNN banners 325 is presenting contextually relevant outage information to the user on the command line interface. In the example shown in FIG. 3F, the CNN banners 325 are presented to the user enters a commend related to a pipeline. The CNN banners 325 may also be presented when the user enters commands related to pipelines, pull requests, and/or other commands for which the outage information may be relevant.

FIGS. 4A-4C are diagrams showing an example user interface 405 of the administration portal 173 of the CNN portal 172 according to the techniques disclosed herein. As discussed in the preceding examples, the CNN portal 172 is developed as an extension to the DevOps platform 170 which accesses the functionality of the CNN platform 102 via the CNN API 112. FIG. 4A shows outage information for current and/or resolved outages. The outage information is entered by an authorized user. The example implementation of the user interface 405 shown in FIG. 4A divides the outages into broad outages and local outages. Broad outages impact a large number of pipelines, repositories, and/or other components of the engineering systems 100. Broad outages may impact many or all of the users of the engineering systems 100. Local outages impact fewer components of the engineering systems 100 and impact fewer of the users of the engineering systems 100. For instance, a local outage may impact a subset of the pipelines, repositories, and/or other components of the engineering systems 100, which prevents users from executing at least some pull requests and/or instantiating at least some pipelines.

FIG. 4B shows a broad outage creation pane 415 and FIG. 4C shows a local outage creation pane 420. The broad outage creation pane 415 enables an authorized user to create a new broad outage, and the local outage creation pane 420 enables the authorized user to create a new local outage. The administration portal 173 submits the outage information for the new broad outage or the new local outage to the CNN API 112 to cause the CNN business logic 114 to store the outage information in the CNN datastore 116. In response to the outage information being added to the CNN datastore 116, the fast fail unit 108 may attempt to cause the pipelines associated with the outage to be disabled for outages associated with hard failures. A hard failure, as used herein, represents a malfunction of one or more components of a pipeline that will cause the pipeline to fail until the malfunction has been corrected. In contrast, the fast fail unit 108 may attempt to restart a pipeline associated with an intermittent failure. An intermittent failure, as used herein, represents a malfunction of one or more components of the pipeline that occasionally causes the pipeline to fail. In some implementations, if sequential attempts to restart the pipeline fail more than a number of times represented by a retry threshold, the fast fail unit 108 updates the outage information to a hard failure and disables the pipeline until the cause of the malfunction is resolved.

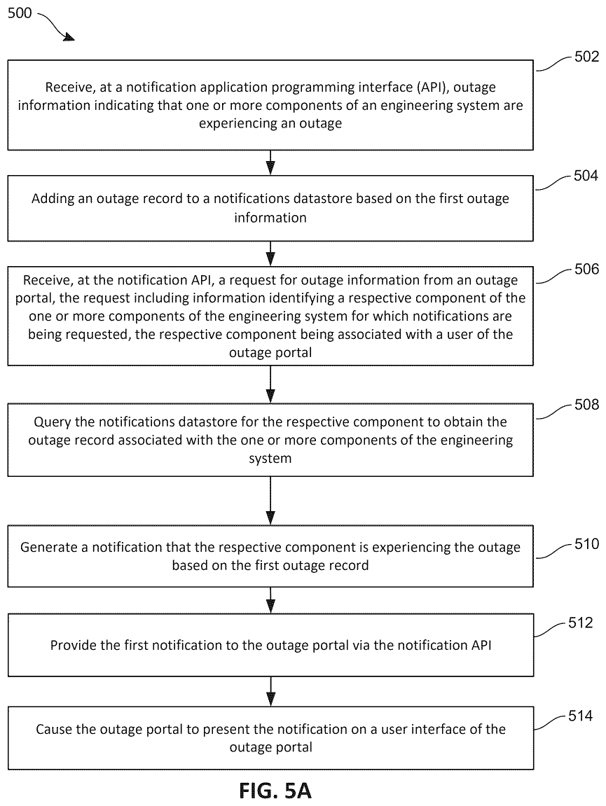

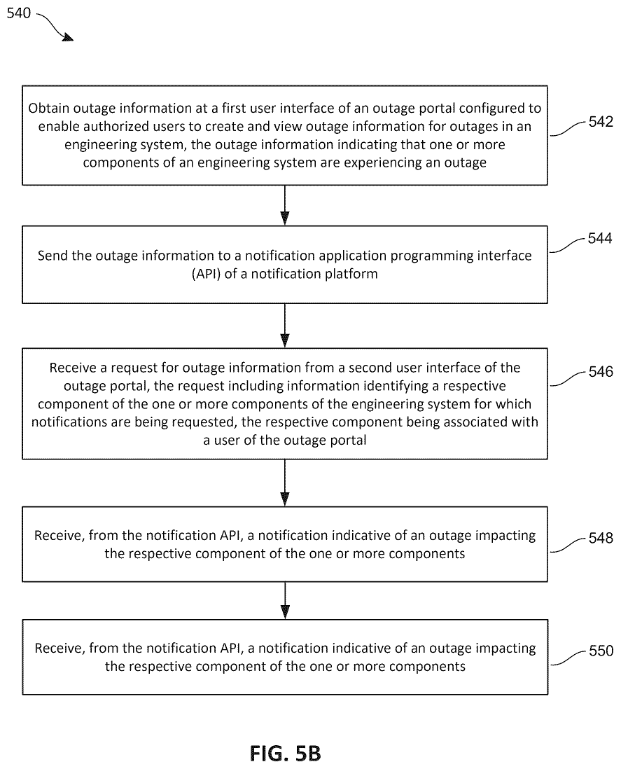

FIG. 5A is a flow chart of an example process 500 for providing contextually relevant notifications according to the techniques disclosed herein. The process 500 can be implemented by the CNN platform 102 discussed in the preceding examples.

The process 500 includes an operation 502 of receiving, at a notification application programming interface (API), outage information indicating that one or more components of an engineering system are experiencing an outage. The CNN portal 172 provides the outage information to the CNN platform 102 via the CNN API 112. The outage information may be input using the user interfaces shown in FIGS. 4A-4C in some implementations.

The process 500 includes an operation 504 of adding an outage record to a notifications datastore based on the outage information. The CNN business logic 114 adds an outage record to the CNN datastore 116 in response to receiving the outage information from the CNN portal 172.

The process 500 includes an operation 506 of receiving, at the notification API, a request for outage information from an outage portal. The request includes information identifying a respective component of the one or more components of the engineering system for which notifications are being requested. The respective component is associated with a user of the outage portal. As discussed in the preceding example, the outage may be associated with various components of the engineering systems 100, such as but not limited to the pipelines, repositories, and/or other components of the engineering system. The outage may also impact pull requests as discussed above.

The process 500 includes an operation 508 of querying the notifications datastore for the respective component to obtain the outage record associated with the one or more components of the engineering system. The CNN business logic 114 queries the CNN datastore 116 to obtain outage records associated with the components specified in the request. The components can include pipelines, pull requests, repositories, and/or other elements of the engineering systems 100.

The process 500 includes an operation 510 of generating a first notification that the respective component is experiencing the outage based on the outage record. The CNN business logic 114 generates a notification based on the outage information obtained from the CNN datastore 116.

The process 500 includes an operation 512 of providing the first notification to the outage portal via the notification API. The CNN API 112 facilitates communication with the CNN portal 172 and provides the notification or notifications generated by the CNN business logic 114 to the CNN portal 172 for presentation to the user on the specific portal component that requested the outage information.

The process 500 includes an operation 514 of causing the outage portal to present the first notification on a user interface of the outage portal. As shown in FIGS. 3A-3F, the notifications can be displayed on the respective user interfaces that the user can access to receive information about the engineering systems 100.

FIG. 5B is a flow chart of another example process 540 for providing contextually relevant notifications according to the techniques disclosed herein. The process 540 can be implemented by the CNN portal 172 discussed in the preceding examples.

The process 540 includes an operation 542 of obtaining outage information at a first user interface of an outage portal configured to enable authorized users to create and view outage information for outages in an engineering system, the outage information indicating that one or more components of an engineering system are experiencing an outage. As shown in FIGS. 4A-4C, the administration portal 173 provides a user interface that enables authorized users to enter a new outage into the system.

The process 540 includes an operation 544 of sending the outage information to a notification application programming interface (API) of a notification platform. The notification API provides an interface for communication with the CNN platform 102.

The process 540 includes an operation 546 of receiving a request for outage information from a second user interface of the outage portal. The request includes information identifying a respective component of the one or more components of the engineering system for which notifications are being requested. The respective component is associated with a first user of the outage portal. The user may access the outage information from the user outages portal 175, the teams outages portal 177, or the command line interface 216.

The process 540 includes an operation 548 of receiving, from the notification API, a first notification indicative of an outage impacting the respective component of the one or more components. The CNN platform 102 generates any contextually relevant notifications and provides these notifications to the outage portal via the CNN API 112.

The process 540 includes an operation 550 of presenting the first notification on the second user interface of the outage portal. The notification is presented on the user outages portal 175, the teams outages portal 177, or the command line interface 216 discussed in the preceding examples.

The detailed examples of systems, devices, and techniques described in connection with FIGS. 1-5B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-5B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module.

Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

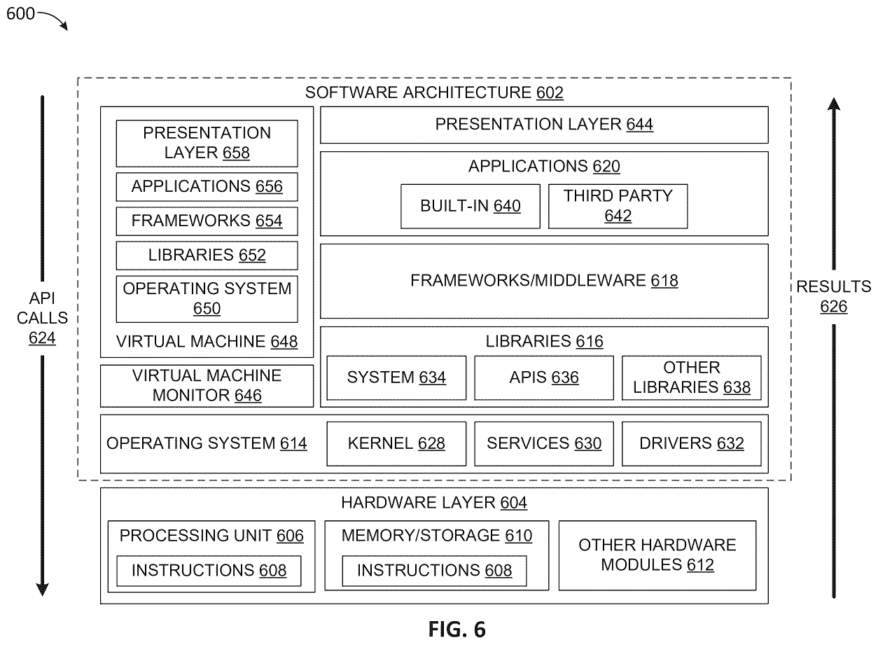

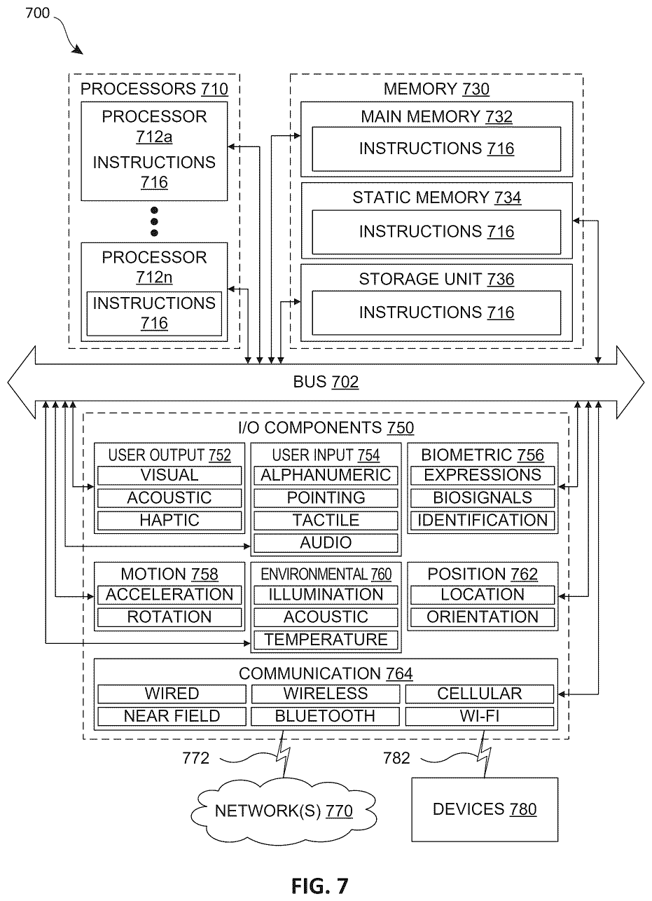

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
receiving, at a notification application programming interface (API), outage information indicating that one or more components of an engineering system are experiencing an outage;
adding an outage record to a notifications datastore based on the outage information;
receiving, at the notification API, a request for outage information from an outage portal, the request including information identifying a respective component of the one or more components of the engineering system for which notifications are being requested, the respective component being associated with a first user of the outage portal;
querying the notifications datastore for the respective component to obtain the outage record associated with the one or more components of the engineering system;
generating a first notification that the respective component is experiencing the outage based on the outage record;
providing the first notification to the outage portal via the notification API; and
causing the outage portal to present the first notification on a first user interface of the outage portal.

2. The data processing system of claim 1, wherein the memory further includes instructions configured to cause the processor alone or in combination with other processors to perform operations of:
determining that the one or more components associated with the outage comprise a first data pipeline; and
configuring the first data pipeline to prevent the first data pipeline from being initialized until the outage has been resolved.

3. The data processing system of claim 2, wherein the memory further includes instructions configured to cause the processor alone or in combination with other processors to perform operations of:
monitoring a status of the outage using an outage auto resolver unit, the outage auto resolver unit being configured to resolve the outage responsive to each incident management ticket of one or more incident management tickets associated with the outage having been resolved.

4. The data processing system of claim 3, wherein the memory further includes instructions configured to cause the processor alone or in combination with other processors to perform operations of:
causing a pipeline restarter unit to reinitialize the first data pipeline responsive to the first data pipeline being reconfigured, the pipeline restarter unit being configured to allocate computing resources for the first data pipeline, configure the computing resources for the first data pipeline, and to instantiate one or more processes associated with the first data pipeline.

5. The data processing system of claim 1, wherein the memory further includes instructions configured to cause the processor alone or in combination with other processors to perform operations of:
determining that the one or more components associated with the outage comprise a plurality of data pipelines; and
causing a pipeline restarter unit to reinitialize the plurality of data pipelines, the pipeline restarter unit being configured to determine an order in which the plurality of data pipelines is reinitialized based on available computing resources and dependencies among the plurality of data pipelines.

6. The data processing system of claim 1, wherein the memory further includes instructions configured to cause the processor alone or in combination with other processors to perform an operation of determining that the first user is authorized to request the outage information.

7. The data processing system of claim 1, wherein the first user interface is a pipeline user interface that provides information regarding one or more pipelines of the engineering system to which the first user has access.

8. The data processing system of claim 1, wherein the first user interface is a pull request user interface that provides information regarding one or more pull requests of the engineering system to which the first user has access.

9. The data processing system of claim 1, wherein the outage portal is a team outage portal that provides outage information for a first team which the first user is a member.

10. A method implemented in a data processing system for providing contextually relevant notifications, the method comprising:
receiving, at a notification application programming interface (API), outage information indicating that one or more components of an engineering system are experiencing an outage;
adding an outage record to a notifications datastore based on the outage information;
receiving, at the notification API, a request for outage information from an outage portal, the request including information identifying a respective component of the one or more components of the engineering system for which notifications are being requested, the respective component being associated with a first user of the outage portal;
querying the notifications datastore for the respective component to obtain the outage record associated with the one or more components of the engineering system;
generating the first notification that the respective component is experiencing the outage based on the outage record;
providing the first notification to the outage portal via the notification API; and
causing the outage portal to present the first notification on a first user interface of the outage portal.

11. The method of claim 10, further comprising:
determining that the one or more components associated with the outage comprise a first data pipeline; and
configuring the first data pipeline to prevent the first data pipeline from being initialized until the outage has been resolved.

12. The method of claim 11, further comprising:
monitoring a status of the outage using an outage auto resolver unit, the outage auto resolver unit being configured to resolve the outage responsive to each incident management ticket of one or more incident management tickets associated with the outage having been resolved.

13. The method of claim 12, further comprising:
causing a pipeline restarter unit to reinitialize the first data pipeline responsive to the first data pipeline being reconfigured, the pipeline restarter unit being configured to allocate computing resources for the first data pipeline, configure the computing resources for the first data pipeline, and to instantiate one or more processes associated with the first data pipeline.

14. The method of claim 12, further comprising:
determining that the one or more components associated with the outage comprise a plurality of data pipelines; and
causing a pipeline restarter unit to reinitialize the plurality of data pipelines, the pipeline restarter unit being configured to determine an order in which the plurality of data pipelines is reinitialized based on available computing resources and dependencies among the plurality of data pipelines.

15. The method of claim 10, wherein the first user interface is a pipeline user interface that provides information regarding one or more pipelines of the engineering system to which the first user has access, and wherein causing the outage portal to present the first notification further comprises presenting the first notification on the pipeline user interface.

16. The method of claim 10, wherein the first user interface is a pull request user interface that provides information regarding one or more pull requests of the engineering system to which the first user has access, and wherein causing the outage portal to present the first notification further comprises presenting the first notification on the pull request user interface.

17. A data processing system comprising:
a processor; and
a memory storing executable instructions that, when executed, cause the processor alone or in combination with other processors to perform operations of:
obtaining outage information at a first user interface of an outage portal configured to enable authorized users to create and view outage information for outages in an engineering system, the outage information indicating that one or more components of an engineering system are experiencing an outage;
sending the outage information to a notification application programming interface (API) of a notification platform;
receiving a request for outage information from a second user interface of the outage portal, the request including information identifying a respective component of the one or more components of the engineering system for which notifications are being requested, the respective component being associated with a user of the outage portal;
receiving, from the notification API, a first notification indicative of an outage impacting the respective component of the one or more components; and
presenting the first notification on the second user interface of the outage portal.

18. The data processing system of claim 17, wherein the second user interface is a pipeline user interface that provides information regarding one or more pipelines of the engineering system to which the user has access.

19. The data processing system of claim 17, wherein the second user interface is a pull request user interface that provides information regarding one or more pull requests of the engineering system to which the user has access.

20. The data processing system of claim 19, wherein the second user interface is a command line interface that enables the user to input commands to interact with various components of the engineering system, and wherein presenting the first notification on the second user interface of the outage portal further comprises presenting the first notification on the pull request user interface.
